(19) United States
(12) Patent Application Publication
(10) Pub. No.: US 2026/0097496 A1
(43) Pub. Date: Apr. 9, 2026

(54) REAL-TIME TASK PRIORITIZATION IN ROBOTS BASED ON USER ROLES

(71) Applicant: Field AI, Inc., Mission Viejo, CA (US)

(72) Inventors: Shayegan OMIDSHAFIEI, Dorchester, MA (US); Dong Ki KIM, Cambridge, MA (US); Aliakbar AGHAMOHAMMADI, Mission Viejo, CA (US); David Fan, Lake Forest, CA (US); Muhammad Fadhil GINTING, Aliso Viejo, CA (US); Sung Kyun KIM, Irvine, CA (US)

(73) Assignee: Field AI, Inc., Mission Viejo, CA (US)

(21) Appl. No.: 19/350,467

(22) Filed: Oct. 6, 2025

Related U.S. Application Data
(60) Provisional application No. 63/704,126, filed on Oct. 7, 2024.

(51) Int. Cl. B25J 9/16

(52) U.S. Cl. CPC B25J 9/1661; B25J 9/1605; B25J 9/161; B25J 9/163

(57) ABSTRACT

A method of and system for priority-based instruction handling in a human-robot interactive system can include receiving a plurality of instructions from a plurality of users, processing the instructions through a priority-based instruction manager, generating prioritized instruction embeddings, inputting the prioritized instruction embeddings into a sequence decision model, and generating at least one robot command. The priority-based instruction manager can be in communication with a database, where the database can include context information about members of the user set. The prioritized instruction embeddings can include the output of a scalar weighting function calculated by the priority-based instruction manager.

### CROSS-REFERENCE TO RELATED APPLICATION

This application claims priority to and the benefit of the filing date of provisional U.S. Patent Application No. 63/704,126, entitled “SYSTEM AND METHOD FOR REAL-TIME TASK PRIORITIZATION IN ROBOTS BASED ON USER ROLES” and filed on Oct. 7, 2024, the entire contents of which are hereby expressly incorporated herein by reference.

### TECHNICAL FIELD

Embodiments of the present disclosure relate to robotic systems, and more particularly to a system and a method for real-time task prioritization in one or more robots based on user roles.

### BACKGROUND

Human-robot interaction (HRI) focuses on enhancing collaboration between one or more robots and one or more users across various environments, including industrial, healthcare, domestic settings, and the like. As the one or more robots become increasingly integrated into complex work environments, such as manufacturing and construction sites, ability to manage and adapt to dynamic team members (users) becomes crucial for achieving efficient and effective operations. Human-robot teams must navigate varying roles, responsibilities, and authority levels, requiring sophisticated systems to handle these interactions smoothly.

Historically, management of the human-robot interactions has relied on static or predefined rules and protocols. Early systems have used simple algorithms and fixed rulesets to manage interactions, leading to rigid and inflexible operations. Existing systems require manual reconfiguration or intervention to accommodate changes in team composition or roles, resulting in inefficiencies and disruptions when the team members were added or removed.

More advanced approaches have introduced limited dynamic adaptation by using rule-based systems that may adjust to some extent, but still lack the ability to fully integrate real-time changes in user presence and roles. While the advanced approaches improved interaction flexibility, they struggle with scalability and adaptability, especially in the environments with rapidly changing team dynamics. The advanced approaches also have not accounted for varying levels of authority among the team members, which may lead to suboptimal task prioritization and coordination.

Additionally, some solutions have employed basic sensor inputs to gather data about human presence, but these solutions were limited in their ability to interpret complex interactions and contextual information. These solutions lack sophisticated mechanisms for recognizing and responding to a hierarchical structure and seniority levels within a team, leading to potential conflicts and inefficiencies in task management.

Overall, prior solutions fall short in addressing the complexities of the dynamic human-robot interactions, leading to inefficiencies, disrupted workflows, and challenges in maintaining effective coordination and task prioritization in the real-time dynamic environments.

Therefore, there is a need for a system to address the aforementioned issues by managing dynamic changes in user roles and presence, and by enabling effective task prioritization according to hierarchical structures.

### SUMMARY

In accord with one general aspect, described herein is a system having a processor and a memory in communication with the processor, wherein the memory includes executable instruction that, when executed by the processor, cause the system to perform multiple functions that include receiving a plurality of instructions from a plurality of users, where the users are members of a user set. These functions can further include processing the instructions through a priority-based instruction manager, where the priority-based instruction manager is in data communication with a database. The database can include context information about members of the user set. These functions can also include generating prioritized instruction embeddings via the priority-based instruction manager that contextualize the received instructions for decision making, and inputting the prioritized instruction embeddings into a sequence decision model. The prioritized instruction embeddings can include the output of a scalar weighting function calculated by the priority-based instruction manager. The functions can further include generating at least one robot command based on the sequential modeling of the prioritized instruction embeddings.

In accord with another general aspect, the method described herein may involve multiple steps. These steps may include receiving a plurality of instructions from a plurality of users, where the users are members of a user set. These steps can further include processing the instructions through a priority-based instruction manager, where the priority-based instruction manager is in data communication with a database. The database can include context information about members of the user set. These steps can also include generating prioritized instruction embeddings via the priority-based instruction manager that contextualize the received instructions for decision making, and inputting the prioritized instruction embeddings into a sequence decision model. The prioritized instruction embeddings can include the output of a scalar weighting function calculated by the priority-based instruction manager. The steps can further include generating at least one robot command based on the sequential modeling of the prioritized instruction embeddings.

In accord with yet another general aspect, the instant disclosure describes a non-transitory computer readable medium on which are stored instructions that when executed cause a programmable device to perform multiple functions. These functions may include receiving a plurality of instructions from a plurality of users, where the users are members of a user set. These functions can further include processing the instructions through a priority-based instruction manager, where the priority-based instruction manager is in data communication with a database. The database can include context information about members of the user set. These functions can also include generating prioritized instruction embeddings via the priority-based instruction manager that contextualize the received instructions for decision making, and inputting the prioritized instruction embeddings into a sequence decision model. The prioritized instruction embeddings can include the output of a scalar weighting function calculated by the priority-based instruction manager. The functions can further include generating one or more robot commands based on the sequential modeling of the prioritized instruction embeddings.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a flow diagram illustrating an example method for robot instruction handling.

FIG. 2 is a flow diagram illustrating an example method for robot instruction handling that includes user feedback.

FIG. 3 is a flow diagram illustrating an example method for robot instruction handling that includes task reprioritization and user identification.

FIG. 4 depicts an example architecture in which the system of the present embodiments may operate.

FIG. 5 is a block diagram showing an example system of the present embodiments along with its corresponding subsystems.

FIG. 6 depicts an example data flow for robot instruction handling of the systems and methods of the present embodiments.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

### Technical Problem

Modern human-robot collaboration in industrial and organizational environments can face significant challenges due to the dynamic and unpredictable nature of human teams. Human teammates frequently join, leave, or change roles mid-operation, which can disrupt task planning and execution. Robotic control systems and static instruction hierarchies can fail to adapt efficiently, requiring manual reconfiguration or interrupting ongoing operations. Moreover, robots can lack the contextual understanding of authority hierarchies or the ability to interpret multimodal human inputs in real time. This can reduce efficiency, increase downtime, and create operational risks in time-critical environments such as warehouses, factories, construction sites, or field operations. The lack of an adaptive, context-aware system to manage dynamic inputs from multiple humans in a coordinated manner highlights the need for a scalable solution that can process multimodal inputs, understand team hierarchy, and dynamically reprioritize tasks without operational disruption.

### Technical Solution

The embodiments disclosed herein introduce priority-based instruction handling systems and methods centered on the interaction between a priority-based instruction manager and a sequence decision model. The priority-based instruction manager can receive human-issued instructions, evaluate the identity, authority level, and contextual role of the users, and generate structured priority signals enriched with situational context. These enriched signals, together with multimodal inputs and contextual memory from the job site, can be transformed into prioritized instruction embeddings. The sequence decision model ingests these embeddings and applies advanced sequential reasoning architectures, such as transformers, recurrent neural networks (RNNs), or long short-term memory (LSTM) networks to determine optimal task ordering, resolve conflicts among directives, and adapt to evolving team compositions. By continuously integrating authority-aware priorities with environmental and operational updates, the sequence decision model can produce execution-ready robot commands that remain responsive to real-time changes. This approach makes it possible for robots to seamlessly adjust to new participants, shifts in authority, or alterations in operational conditions without disrupting ongoing tasks. The coordinated operation of the priority-based instruction manager and the sequence decision model thereby creates a robust, adaptive framework that enables robots to reason about team structure, operational context, and task prioritization, resulting in efficient and context-sensitive human- robot collaboration.

### Advantages of the Technical Solution

The disclosed embodiments can have several key advantages over conventional static systems. First, they allow for real-time adaptability, ensuring robots seamlessly incorporate new team members or adjust to personnel changes without halting operations. Second, they introduce contextual prioritization, leveraging identity and authority data to ensure instructions from higher-ranking personnel receive appropriate execution precedence, aligning robotic actions with organizational hierarchies. Third, the use of foundation model-driven sequential reasoning enables continuous learning and scalability across varied environments, reducing the need for site-specific programming. Finally, the feedback and coordination capabilities improve situational awareness among human teammates, promoting safer and more efficient collaboration. These advancements collectively enhance operational continuity, reduce downtime, and enable robots to function as intelligent, context-aware collaborators in complex and evolving industrial environments.

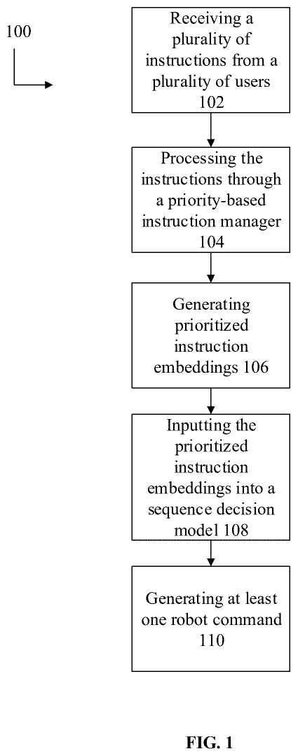

FIG. 1 is a flow diagram illustrating an example method 100 for robot instruction handling in accordance with the present disclosure. The method 100 can include receiving a plurality of instructions from a plurality of users (Step 102). Raw task instructions can be received from multiple users forming the user set. The user set may include site managers, project directors, individual contributors, or any combination of authorized personnel present in the defined job site or operational area. The user set can also be defined as whatever persons are within a defined geographical area, such as a factory or job site, regardless of whether or not the person is authorized to perform a specified task. Instructions can be communicated through various channels, such as handheld devices, voice commands, or other human-machine interfaces, such as a touch screen located on the robot. The received instructions can be multimodal in nature, reflecting different communication forms, and can arrive concurrently from different sources. At this stage, no prioritization or contextualization is necessarily performed. The primary purpose is to capture instructions uniformly, preserving both the content of the directives and any metadata such as time, origin, or modality of submission. These inputs provide the raw material for downstream processing by ensuring that all task-related communications are reliably ingested into the system. The output of this block is a structured stream of unprocessed instructions, tagged with user identifiers or session markers. These outputs are then directed to the priority-based instruction manager, where contextual evaluation and prioritization are applied. In this way, the system ensures no directive is lost at the intake stage, supporting robust and adaptive task management.

The method 100 can include processing the instructions through a priority-based instruction manager (Step 104). Step 104 embodies the contextual reasoning layer that transforms raw instructions into ranked, authority-aware directives. The priority-based instruction manager can be configured to be in data communication with a job-site database containing role, identity, and contextual information about members of the user set. When instructions are received, the priority-based instruction manager can evaluate the associated user's identity, authority level, and contextual role by cross-referencing database records and multimodal input signals such as ID credentials, task logs, or environmental context. The priority-based instruction manager can apply a scalar weighting function that assigns each instruction a numerical priority value based on hierarchical authority, task relevance, and situational urgency. These weightings ensure that directives issued by higher-ranking personnel or mission-critical instructions receive precedence over less urgent or lower-authority commands. The block further incorporates site contextual memory, allowing prioritization decisions to adapt based on evolving team composition or environmental conditions. The output of this stage is a set of enriched instruction data points, each tagged with authority-derived priority values and contextual embeddings. These can be forwarded as prioritized instruction embeddings. This conversion provides downstream decision models with the information to reason not only on the content of directives but also on their organizational and contextual significance.

The method 100 can include generating prioritized instruction embeddings (Step 106). At Step 106, weighted, contextualized instructions can be converted into machine-readable embeddings suitable for sequential modeling. Each instruction embedding can include the directive itself, the associated priority score, and contextual tags such as user identity, authority level, role, and situational variables drawn from site memory. The embeddings can be structured vector representations that allow the system to capture both semantic content and priority metadata in a unified format. This embedding process can transform heterogeneous instructions from multiple modalities into a standardized representational space that can be effectively processed by neural sequence models. In practice, this means that the system does not simply forward commands as text or discrete events, but rather encodes them into rich, numerical representations that support temporal reasoning and pattern recognition. The embeddings also preserve adaptability, meaning that if a team composition changes or a higher-ranking user enters the operational context, the weighting can be updated dynamically without regenerating the raw instruction. Step 106 provides for prioritized embeddings containing both directive semantics and priority values. These can be passed directly into the sequence decision model, ensuring that subsequent decision-making incorporates both the instructions'substantive meaning and their contextual importance.

The method 100 can include inputting the prioritized instruction embeddings into a sequence decision model (Step 108). The sequence decision model ingests prioritized instruction embeddings and applies advanced sequence modeling techniques—such as transformers, RNNs, or LSTM networks—to generate coherent task execution strategies. The model can thereby treat each user as a dynamic multimodal input, incorporating not only the directive but also the user's presence, authority, and role as contextual signals. By processing the embeddings in sequence, the decision model is capable of reasoning over time, handling dependencies among tasks, and ensuring that ongoing operations remain uninterrupted when new participants join or existing members leave. This sequential reasoning capability thereby allows the system to dynamically adapt workflows, determine the optimal ordering of tasks, and align execution with organizational hierarchies. At Step 108, structured decision outputs in the form of ordered action sets, preliminary robot command sequences, or state updates that reflect priority alignment can be formed to generate a robot task.

The method 100 can include generating at least one robot command (Step 110). At Step 110, the method can transform modeled task outputs into execution-ready robot commands. The inputs from the sequence decision model are already contextualized and prioritized; at this stage, they are translated into actionable instructions for one or more robots on the job site. The system formats commands in accordance with the robots' control interfaces, ensuring compatibility across different robotic platforms, whether quadrupeds, drones, or wheeled units. The block may also generate updates to a robot's task queue, enabling real-time adjustments without interrupting ongoing tasks. In addition to command generation, the method can also support a feedback loop by transmitting task prioritization status and execution progress back to human teammates via an interface. This feedback can provide that operators remain aware of which tasks are being executed and why certain instructions were prioritized. The outputs of Step 110 can thereby be twofold: (i) low-level robot control signals that enable physical task execution, and (ii) high-level feedback to the user set to support collaboration and situational awareness. Together, these outputs can provide that that the system achieves its goal of adaptive, authority-aware, and seamless human-robot task coordination.

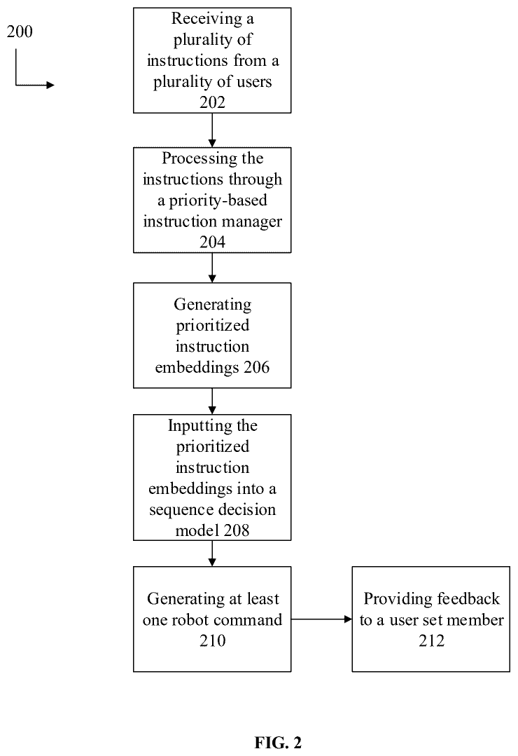

FIG. 2 is a flow diagram illustrating an example method 200 for robot instruction handling that includes user feedback. Steps 202, 204, 206, 208, and 210 can be identical to those described with regard to FIG. 1, and, for the sake of brevity, are not described further here.

The method 200 can include providing feedback to a user set member (Step 212). Step 212 represents a collaborative feedback layer of the method, ensuring that human teammates remain informed about task prioritization and robot execution status. Based on the sequence decision model generation of robot commands and integration into workflows, the system produces structured feedback for relevant users. The feedback may include which instruction was prioritized, why it received precedence (e.g., authority level, urgency, or contextual relevance), and the current status of execution by the robot. This feedback is not necessarily uniform, and can be tailored to the role and authority level of the recipient. For example, a site manager may receive a detailed breakdown of the robot's task queue, while an individual contributor might only be informed about execution progress for their specific directive. This feedback can be based on execution results from robots, prioritization metadata from the instruction manager, and contextual data from the job-site database. These inputs are converted into comprehensible messages or visual dashboards delivered via communication devices such as handheld tablets, wearable devices, or control panels. The outputs can be human-readable updates that close the loop between the system and its human teammates, thereby enabling transparency and enhanced situational awareness in human-robot collaboration.

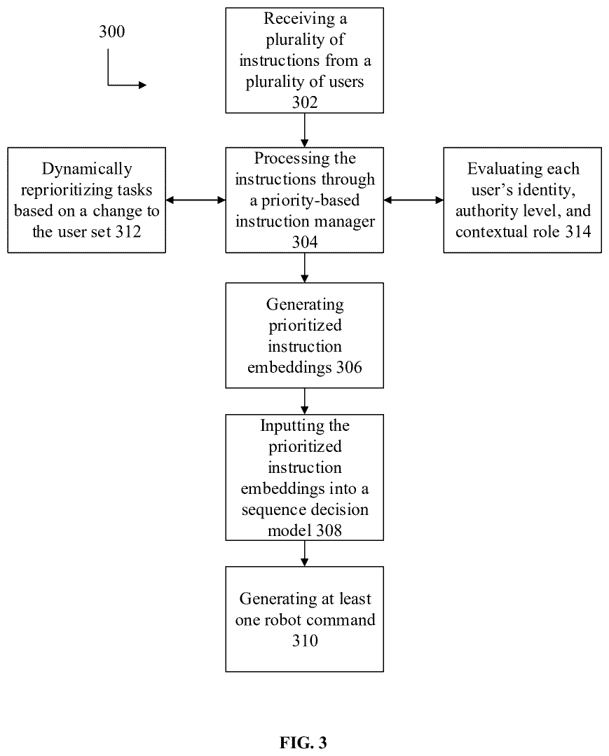

FIG. 3 is a flow diagram illustrating an example method 300 for robot instruction handling that includes task reprioritization and user identification. Steps 302, 304, 306, 308, and 310 can be identical to those described with regard to FIG. 1 and FIG. 2, and, for the sake of brevity, are not described further here.

The method 300 can include dynamically reprioritizing tasks based on a change to the user set (Step 312). At Step 312, the method 300 can adapt to real-time changes in the user set. The user set in industrial and organizational environments is inherently dynamic, with individuals joining or leaving as shifts change, as operational needs evolve, or with personnel entering and leaving an operational or organization environment for other reasons. When such changes occur, previously assigned priorities may no longer reflect the optimal task allocation. The priority-based instruction manager can receive real-time updates regarding user set composition from sensors, communication devices, or the job-site database. It then can reevaluate instruction weightings by recalculating the scalar priority functions associated with each directive. For example, if a high-ranking supervisor arrives on site, their commands can be immediately weighted higher than those from lower-ranking contributors, even if those contributors'instructions were initially prioritized. Similarly, if a team member leaves, their instructions may be downgraded or reallocated. Step 312 thereby provides that the system's prioritization layer remains aligned with the current authority structure and task demands. The output of this step is an updated set of prioritized instruction embeddings, which are then re-ingested by the sequence decision model without interrupting ongoing robot operations.

The method 300 can include evaluating each user's identity, authority level, and contextual role (Step 314). At Step 314, the method can incorporate updated hierarchical and contextual reasoning into task management. The identity detection subsystem can receive multimodal input signals such as ID badge scans, biometric data, or communication metadata, and cross-references them against the job-site database. The database contains detailed records of each user's role, seniority, and authorized responsibilities. Using this information, the subsystem evaluates not only who the user is but also what level of authority and contextual responsibility they hold at the job site, even in the context of a change to the user set. For example, a project director's directives will be flagged as high priority, while those from a trainee may be deprioritized unless context requires otherwise. This can not only apply to user set hierarchy but can extend to task relevance—if a user is actively engaged in a specific operational area, their inputs may be given additional weight, especially if safety or mission-critical concerns arise. Step 314 can include mapping raw identity and role signals into structured authority-weighted embeddings that can be used by the priority-based instruction manager. The outputs are authority-ranked user profiles and contextual role assignments that inform the reprioritization process and subsequent decision modeling. This provides that the system not only responds to instructions but does so in alignment with organizational structures and site-specific context.

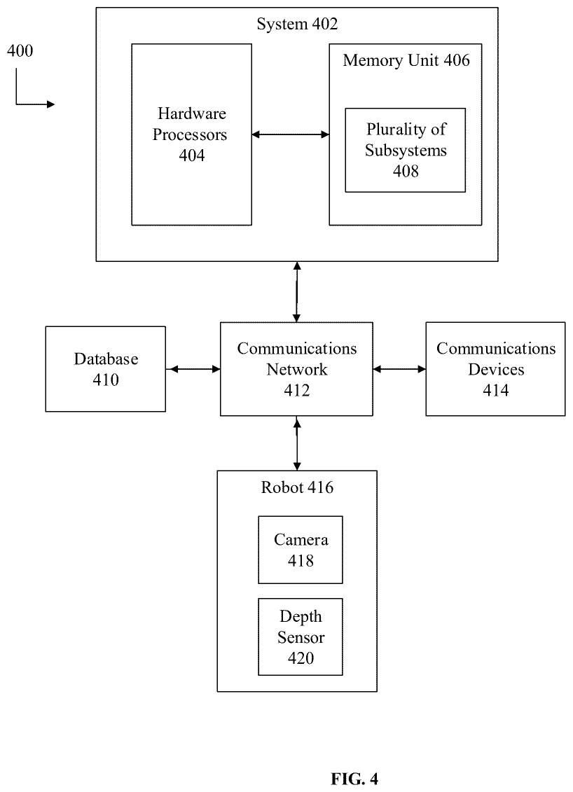

FIG. 4 depicts an example architecture 400 in which the system 402 of the present embodiments may operate. The architecture 400 can include a system 402, database 410, communications network 412, communications devices 414, and robot 416. The system 402 can include hardware processors 404 and a memory unit 406.

The architecture 400 can include a system 402 that includes a hardware processor 404. The one or more hardware processors 404, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 404 may also include embedded controllers, such as generic or programmable logic devices or arrays, application-specific integrated circuits, single-chip computers, and the like.

The memory unit 406 can include a plurality of subsystems 408. The memory unit 406 may be the non-transitory volatile memory and the non-volatile memory. The memory unit 406 may be coupled to communicate with the one or more hardware processors 404, such as being a computer-readable storage medium. The one or more hardware processors 404 may execute machine-readable instructions and/or source code stored in the memory unit 406. A variety of machine-readable instructions may be stored in and accessed from the memory unit 406. The memory unit 406 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 406 can include the plurality of subsystems 408.

The plurality of subsystems 408 can be stored in the form of machine-readable instructions on any of the above-mentioned storage media and may be in communication with and executed by the one or more hardware processors 404. A computer system (standalone, client or server computer system) configured by an application may constitute a “module” (or “subsystem”) that is configured and operated to perform certain operations. In one embodiment, the “module” or “subsystem” may be implemented mechanically or electronically, so a module can include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The architecture 400 can include a database 410. The database 410 may include, but not limited to, storing, and managing data related to the user set, including organizational structure, tasks, and priorities. The database 410 can serve as a central repository for all relevant data for cross-referencing by the priority-based instruction manager, enabling efficient data retrieval and analysis to support decision-making processes. The database 410 can contain the information required for the identity detection subsystem to receive multimodal input signals such as ID badge scans, biometric data, or communication metadata, and cross-reference them against the job-site database. The database 410 can include contains detailed records of each user's role, seniority, and authorized responsibilities. Using this information, the subsystem evaluates not only who the user is but also what level of authority and contextual responsibility they hold at the job site, even in the context of a change to the user set. The database 410 can include previous instructions and sensory data, and can thereby facilitate updating the priority-based instruction manager, as well as navigation within the environment. Furthermore, the database 410 may manage user access controls, configuration settings, and system logs, providing a comprehensive solution for data management and security within the network architecture.

The architecture 400 can include a communications network 412. The communications network 412 can include one or more communications networks 412 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-ﬁ), cellular networks (including 4G (fourth generation), 5G (fifth generation), and 4G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The communication networks 412 can be configured to facilitate data exchange and communication between the system 402 and the database 410 for real-time data analysis.

The architecture 400 can include communications devices 414. The communications devices 414 can be one or more communication devices 414 and may represent various network endpoints, such as, but not limited to, user devices, mobile devices, smartphones, Personal Digital Assistants (PDAs), tablet computers, phablet computers, wearable computing devices, Virtual Reality/Augmented Reality (VR/AR) devices, laptops, desktops, display interface panels, control panels, human machine interface panels, liquid crystal display (LCD) screens, light-emitting diode (LED) screens, and the like. The one or more communication devices 414 can be configured to function as an intermediate unit between the system 402 and one or more users. The one or more communication devices 414 can be equipped with a user interface that allows the one or more users to interact with the system 402. The user interface may include graphical displays, touchscreens, voice recognition, and other input/output mechanisms that facilitate easy access to data and control functions. Any other instructions may be provided by one or more users to the system 402 via the user interface.

The architecture 400 can include a robot 416, which can be one or more robots 416. The robot 416 can be, but are not necessarily restricted to, at least one of a quadruped, wheeled robot, biped, drone, and the like. The robot 416 can communicate with the system 402, communications devices 414, and database 410 via the communications network 412.

The robot 416 can include at least one camera 418 and at least one depth sensor 420. The camera 418 and depth sensor 420 are configured to track the movement of the one or more robots 416, assisting the one or more robots 416 in understanding its position and orientation within the complex scene. The camera 418 can be one or more RGB cameras and the depth sensor 420, which can be one or more depth sensors, are configured to capture both color information and depth data, which indicates how far away objects are in the environment.

Those of ordinary skilled in the art will appreciate that the hardware depicted in FIG. 4 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 402 as is unique to the present disclosure or necessary for an understanding of the present disclosure is depicted and described. The remainder of the construction and operation of the system 402 may conform to any of the various current implementations and practices that were known in the art.

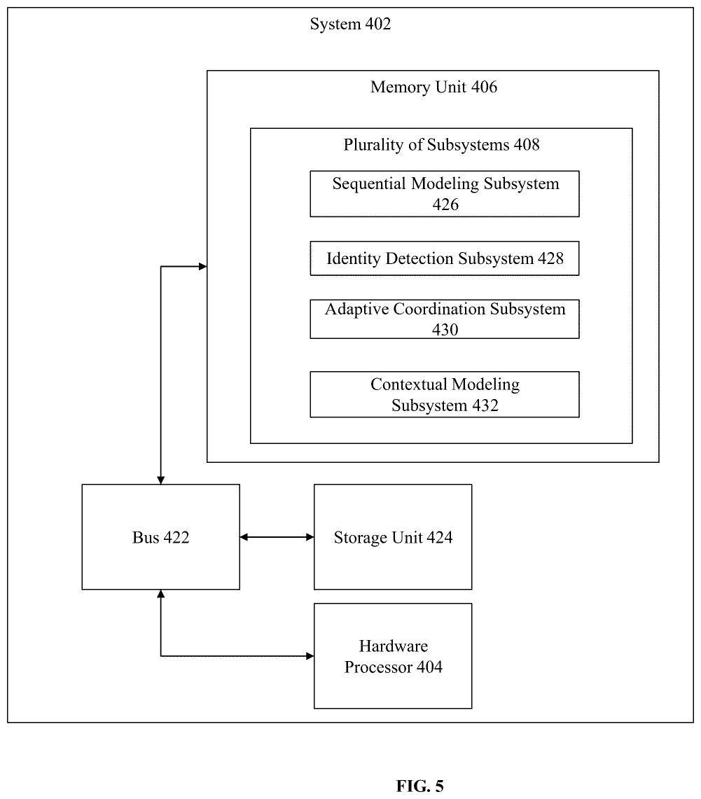

FIG. 5 is a block diagram showing an example system 400 of the present embodiments along with its corresponding subsystems. The system 402 can include a memory unit 406, bus 422, storage unit 424, and hardware processor 404. The memory unit 406 can include a plurality of subsystems 408, which can include a sequential modeling subsystem 426, an identity detection subsystem 428, an adaptive coordination subsystem 430, and a contextual modeling subsystem 432.

The system 402 can include a memory unit 406. The memory unit 406 can be identical to the memory unit 406 described in FIG. 4, and for the sake of brevity, is not described further here.

The system 402 can include a bus 422. The system bus 404 can function as a central conduit for data transfer and communication between the one or more hardware processors 404, the memory unit 406, and the storage unit 424. The system bus 422 facilitates the efficient exchange of information and instructions, enabling a coordinated operation of the system 402. The system bus 422 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system can include a storage unit 424. The storage unit 424 may be a cloud storage or the database 410, such as those shown in FIG. 4. The storage unit 424 may store, but not limited to, recommended course of action sequences dynamically generated by the system 402. These action sequences can include data-obtaining, data processing, instruction interpreting, robot navigation, and the like. The storage unit 424 may be any kind of database such as, but not limited to, relational databases, dedicated databases, dynamic databases, monetized databases, scalable databases, cloud databases, distributed databases, any other databases, graph databases, vector databases, and a combination thereof.

The system 402 can include a sequential modeling subsystem 426. The sequential modeling subsystem can receive prioritized instruction embeddings generated by the priority-based instruction manager and validated through evaluation. Each embedding can include both semantic task content and a scalar priority score derived from user authority, contextual role, and situational urgency. Using advanced sequence modeling architectures, which can include transformers, recurrent neural networks, long short-term memory networks, and combinations thereof, the subsystem can analyze the temporal and relational structure among instructions. This enables the system to identify dependencies, optimize ordering, and integrate new or departing users without disrupting ongoing workflows. The sequential modeling subsystem 426 can treats each human teammate as a dynamic multimodal input, allowing the model to adjust decision-making in real time as personnel composition shifts. Sensor data, which may include data from red-green-blue cameras, depth sensors, and microphones, can also be incorporated to ensure situational feasibility of planned tasks. The outputs can be structured, context-aware command sequences for robots that balance organizational hierarchy, environmental constraints, and temporal coherence. These commands are forwarded to the robot for execution by way of actionable control signals. By embedding authority-aware prioritization into sequential reasoning, subsystem 426 ensures that the robots'actions are both adaptive and organizationally aligned, enabling seamless collaboration in dynamic, real-world environments.

The system 402 can include an identity detection subsystem 428. The identity detection subsystem 428 can establish who issued each instruction, what role they occupy, and the level of authority they hold within the organizational hierarchy. Inputs to this subsystem can include multimodal identification signals such as badge scans, biometric data, voice recognition, communication metadata, contextual and location information, and login credentials. This information can be cross-referenced against the job-site database, which can store detailed records of user profiles, authority levels, and task responsibilities. The identify detection subsystem 428 can be a portion of the priority-based instruction manager, and can generate structured outputs that associate each instruction with an identity tag, a verified authority classification, and a contextual role assignment. For example, instructions from a project director may be encoded with high-authority weighting, while those from an individual contributor can be associated with lower precedence unless situational factors dictate otherwise. The conversion process transforms raw identity signals into role-weighted metadata that is directly embedded into the instruction vectors used by downstream reasoning components. These enriched embeddings can be passed to both the contextual modeling subsystem and the sequential modeling subsystem. By ensuring that instructions are reliably linked to user identity and authority, the identify detection subsystem 428 provides for decision-making that aligns with organizational structures.

The system 402 can include an adaptive coordination subsystem 430. The adaptive coordination subsystem 430 can be another functional component of the priority-based instruction manager, and can be tasked with maintaining seamless operational flow despite changes in team composition or environmental context. The adaptive coordination subsystem 430 can ingest dynamic updates in the user set, which can regard team membership, user roles, and contextual events from both the identity detection subsystem and sensory inputs. For example, when a new user joins or an existing member leaves the operational area, subsystem 430 can recalculate task priorities and adjust workflows accordingly. The adaptive coordination subsystem 430 can process previously weighted instruction embeddings, reassigning or reprioritizing them based on the updated user set. For example, if a senior supervisor arrives on-site, commands issued by that individual are immediately elevated, even if lower-priority tasks are already queued. Conversely, if a user leaves the site, their associated directives can be downgraded or reassigned without disrupting current robot activity. Outputs of this adaptive coordination subsystem 430 can include updated instruction embeddings and task schedules that are transmitted to the sequential modeling subsystem for final reasoning. The adaptive coordination subsystem 430 thereby enables that task execution is resilient to real-time variability, maintaining continuity and operational efficiency. By integrating context-sensitive adaptation into the prioritization process, the adaptive coordination subsystem 430 enhances the robots'ability to function collaboratively and responsively in dynamic environments where human presence and authority are constantly shifting.

The system 402 can include a contextual modeling subsystem 432. The contextual modeling subsystem 432 can also be included in the priority-based instruction manager, and it can serve as the layer that enriches instructions with situational and environmental context. Its inputs include raw and weighted directives from the identity detection subsystem 426, as well as external signals such as sensor data, job logs, and site-specific parameters stored in the database. The contextual modeling subsystem 432 can apply contextual reasoning to determine the relevance and situational weight of each instruction. For example, a directive from a mid-level engineer may receive higher effective weight if it relates directly to a task in progress, or if sensor data indicate urgency (e.g., a safety risk). The contextual modeling subsystem 432 can encode this information into contextual embeddings that combine authority, identity, and situational relevance into a unified representation. Outputs of the contextual modeling subsystem 432 can be prioritized embeddings that can include context tags that are passed forward to the adaptive coordination subsystem and sequential modeling subsystem. Thereby, the embeddings allow the downstream models to reason not only about authority and temporal order but also about situational appropriateness. By integrating real-world context into task prioritization, the contextual modeling subsystem 432 can enable robotic actions that are not only organizationally aligned but also operationally practical and sensitive to evolving site conditions.

Though few components and a plurality of subsystems 408 are disclosed in FIG. 5, there may be additional components and subsystems which are not shown, such as, but not limited to, ports, routers, repeaters, firewall devices, network devices, the database 410, network attached storage devices, assets, machinery, instruments, facility equipment, emergency management devices, image capturing devices, any other devices, and combination thereof. The person skilled in the art should not be limiting the components/subsystems shown in FIG. 5. Although FIG. 5 illustrates the system 402, and the one or more communication devices 414 connected to the database 410, one skilled in the art can envision that the system 402, and the one or more communication devices 414 may be connected to several user devices located at various locations and several databases via the one or more communication network 412.

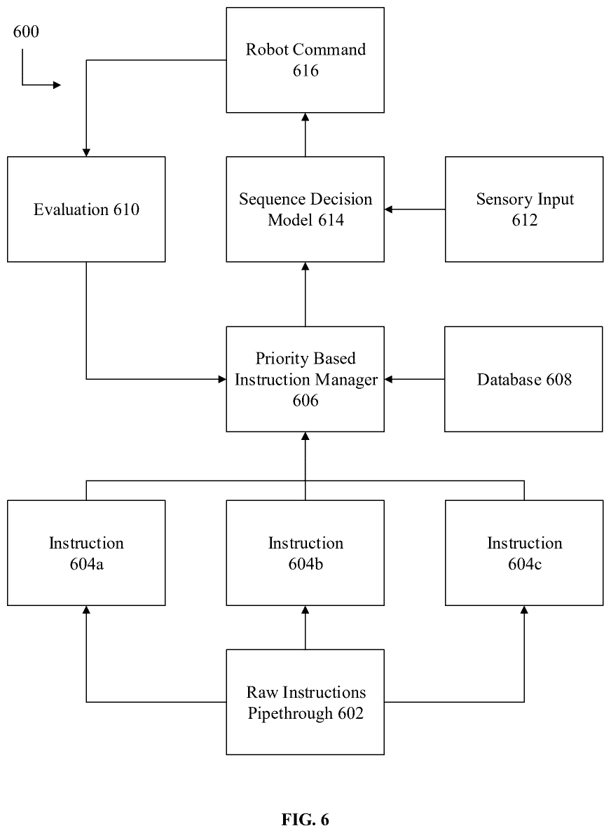

FIG. 6 depicts an example data flow 600 for robot instruction handling of the systems and methods of the present embodiments. The raw instructions pipethrough 602 can serve as the input aggregation layer. It collects unprocessed instructions originating from multiple human teammates, which may include project directors, site managers, or individual contributors within a user set. These inputs arrive through various modalities, such as spoken commands, typed entries, or control panel selections. At this stage, no ranking, validation, or contextual interpretation is necessarily performed. The raw instructions pipethrough 602 can provide that all instructions are uniformly captured and stored in a structured format, preserving metadata such as time, origin, and modality. The pipethrough 602 acts as a conduit, preventing loss of information while preparing the directives for downstream prioritization. Its outputs are unprocessed but structured instruction streams that can be routed to the priority-based instruction manager. This provides that subsequent layers operate on a complete and accurate record of human-provided directives, enabling fair evaluation across authority levels and roles.

From the raw instructions pipethrough 602 can be parsed instructions 604a, 604b, 604c. These can be the specific inputs from different categories of users. For example, instruction A 604a may originate from a site manager, instruction B 604b from an individual contributor, and instruction C 604c from a project director. The distinction illustrates the variability in authority levels and contextual roles across the user set. Each instruction, regardless of source, is transmitted into the system via the raw instructions pipethrough 602. Instructions A-C 604a, 604b, 604c show the multimodal and hierarchical nature of the input space, where authority levels can range from high-level directives issued by executives to granular, task-specific suggestions from contributors. While functionally similar at the raw intake stage, the system later distinguishes among them by applying contextual weighting. These instructions 604a-604c highlight that the system must account for a heterogeneous mix of users with differing responsibilities and seniority, forming the foundation for authority-sensitive prioritization.

The priority-based instruction manager 606 can receive the instructions 604a-604c and can be the core contextual reasoning layer. The instructions can be cross-referenced with job-site context information stored in the database. The priority-based instruction manager 606 can evaluate each instruction according to the identity, role, and authority level of the issuing user. Inputs can include multimodal signals (e.g., ID verification, task logs, biometric data) and static/dynamic records from a job-site database. The priority-based instruction manager 606 can apply a scalar weighting function that assigns a numerical priority score to each instruction. This function factors in authority hierarchy, task urgency, and situational relevance, thereby enabling that instructions from higher-ranking personnel or mission-critical tasks receive precedence. The outputs of this block are enriched prioritized instruction embeddings that combine directive semantics with weighted contextual data. These embeddings can be passed to the sequence decision model so that downstream processing incorporates both the meaning and the relative importance of human directives.

The database 608 can provide a contextual memory backbone. It can store detailed user profiles, including identity, role, authority level, and task history, as well as site-specific contextual information. Inputs to the database include real-time identity signals (e.g., badge scans, biometric authentication), updates from communication devices, and logs from prior task execution. When accessed by the priority-based instruction manager or evaluation stage, the database can provide the necessary context to assign authority-sensitive weightings to instructions. It also can enable continuity across dynamic team changes, maintaining an updated record of which users are currently present and active. The outputs are structured role and authority data delivered to both the priority-based instruction manager. By acting as a trusted reference point, the database 608 can provide that prioritization decisions are not arbitrary but grounded in organizational context and historical records, making task allocation both accurate and transparent.

Human instructions can be supplemented in the sequence decision model by sensory input 612, which can provide the sequence decision model with real-time environmental data. Inputs can originate from robot-mounted sensors, site monitoring devices, and external feeds such as cameras, microphones, and depth sensors. These signals can capture environmental context—such as obstacle presence, equipment status, or team member proximity—that may influence task execution. Sensory data can be integrated with human directives, enabling the system to align task prioritization not only with authority hierarchy but also with situational safety and feasibility. For example, even a high-priority directive may be delayed if sensory input indicates an immediate hazard. The sensory input 612 data can be normalized and contextualized before being transmitted into the sequence decision model. Outputs include structured sensor-informed variables that can directly influence task weighting and execution. This block provides for the systems and methods remaining grounded in real-world conditions, making robotic actions safer, more reliable, and context-aware.

Prioritized instruction embeddings can be converted into actionable robot commands by the sequence decision model 614. Inputs can come from the priority-based instruction manager and can include embeddings supplemented with sensory data. The sequence decision model 614 can employ advanced sequence modeling techniques such as transformers, RNNs, LSTM networks, and combinations thereof. These architectures allow the model to treat each human teammate as a dynamic multimodal input, adapting in real time as users join or leave the operational context. By analyzing instruction embeddings in temporal sequence, the model can identify dependencies, task ordering, and contextual transitions, which, in tandem with the scalar weights provided by the priority-based instruction manager, can optimize alignment of actions with both authority structures and environmental conditions. The outputs are structured robot command sequences optimized for execution. These can be transmitted downstream to the robot. The sequence decision model 614 provides that the robots'behavior is not reactive to isolated directives but reflects coherent, adaptive, and authority-aligned decision-making across the entire operational sequence.

The output of the sequence decision model can be at least one robot command 616. The robot commands 616 can be the output of the sequence decision model and be actionable sequences to be performed by the robot within a job site environment. It translates optimized command sequences can be translated into control signals that are compatible with the specific robotic platforms in use, whether drones, wheeled vehicles, quadrupeds, or manipulation devices. The robot commands 616 can also update task queues in real time, thereby enabling that ongoing operations can adapt dynamically based on a change in priority. Such changes can include further command sequences from the sequence decision model, contextual validation from evaluation, and feedback from sensory inputs provided by the sequence decision model to refine execution timing. The robot commands 616 can include low-level actuator commands transmitted directly to robots, as well as high-level feedback signals to human teammates for evaluation. This feedback may include task progress updates, completion status, or explanations of why certain instructions were prioritized. Thereby, the robot commands 616 closes the operational loop by enabling physical execution while preserving collaborative transparency with the user set.

The robot commands can further proceed to evaluation 610. Evaluation 610 can be performed at an interface based on such feedback as progress updates, completion status, or explanations of why certain instructions were prioritized. Evaluation 610 can serve as both an intermediate analysis stage that validates the assigned priorities and contextual embeddings generated by the priority-based instruction manager and passed to the sequence decision model, and can also serve to update the priority-based instruction manager. A human user can compare the weighted instruction outputs against organizational rules, operational constraints, and site-specific conditions to ensure accuracy. Evaluation 610 may involve conflict resolution, such as identifying contradictory commands from multiple users and determining which instruction should take precedence based on authority or situational urgency, and can enable consistency checks, ensuring that generated embeddings remain aligned with both static rules (e.g., company authority hierarchy) and dynamic site conditions (e.g., safety overrides, time-sensitive events). The output is a refined, validated set of prioritized instruction embeddings that can update the priority-based instruction manager. By serving as a validation checkpoint and means of continuous improvement, evaluation 610 can minimize the risk of erroneous prioritization and strengthens the reliability of downstream command generation.

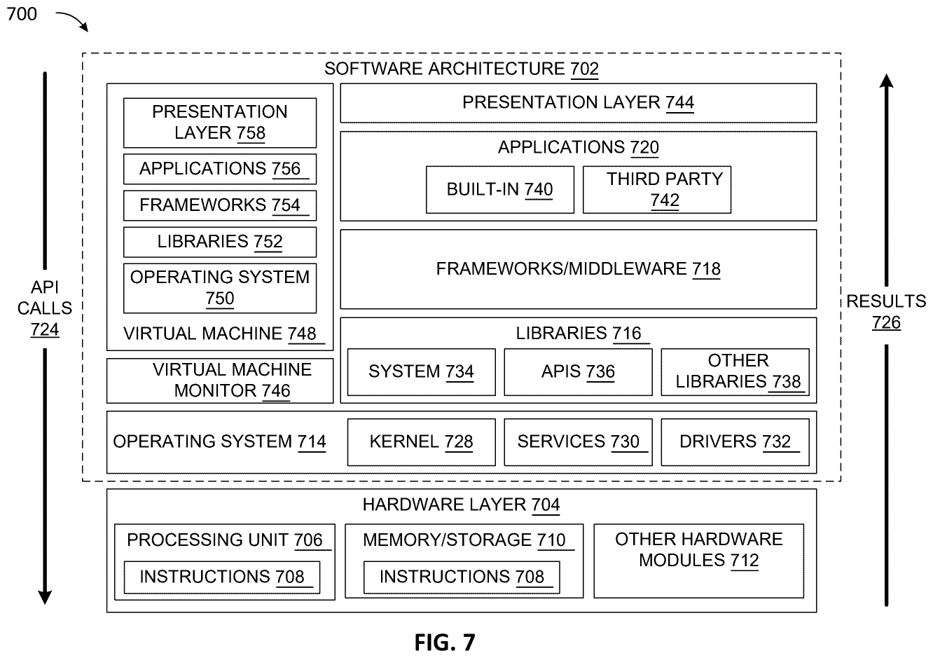

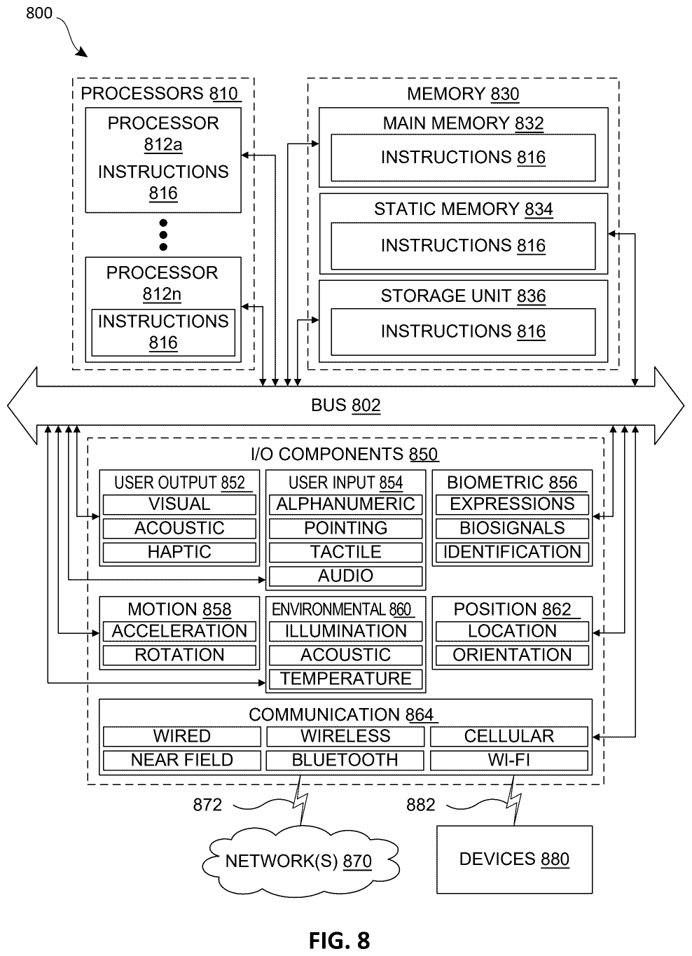

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A method for priority-based instruction handling in a human-robot interactive system, the method comprising:
receiving a plurality of instructions from a plurality of users, wherein the users are members of a user set;
processing the instructions through a priority-based instruction manager, wherein the priority-based instruction manager is in data communication with a database, and wherein the database comprises context information about members of the user set;
generating prioritized instruction embeddings via the priority-based instruction manager that contextualize the received instructions for decision making;
inputting the prioritized instruction embeddings into a sequence decision model to generate a sequential modeling of the prioritized instruction embeddings, wherein the prioritized instruction embeddings include an output of a scalar weighting function calculated by the priority-based instruction manager; and
generating at least one robot command based on the sequential modeling of the prioritized instruction embeddings.

2. The method of claim 1, wherein the sequence decision model comprises a neural network trained for sequential modeling of dynamic human interaction, and is selected from a transformer, a recurrent neural network, or a long short-term memory network.

3. The method of claim 1, wherein the user set is defined by persons present within a defined geographical area, an organized set of persons with authorization to perform a specified task, and combinations thereof.

4. The method of claim 1, wherein the priority-based instruction manager dynamically reprioritizes tasks based on a change to the user set, and wherein the priority-based instruction manager is configured to evaluate each user's identity, authority level, and contextual role using multimodal inputs, site contextual memory, and combinations thereof.

5. The method of claim 4, wherein evaluating the user's identity and authority level includes cross-referencing user data with a database to determine the authority levels and contextual role.

6. The method of claim 1, wherein the generated robot commands are configured to update a robot's task queue in real time.

7. The method of claim 1, further comprising:
providing feedback to a user set member, wherein the feedback includes task prioritization information and command execution status information.

8. A system comprising:
a processor; and
a memory in communication with the processor, the memory comprising executable instructions that, when executed by the processor, cause the system to perform functions of:
receiving a plurality of instructions from a plurality of users, wherein the users are members of a user set;
processing the instructions through a priority-based instruction manager, wherein the priority-based instruction manager is in data communication with a database, wherein the database comprises context information about members of the user set;
generating prioritized instruction embeddings via the priority-based instruction manager that contextualize the received instructions for decision making;
inputting the prioritized instruction embeddings into a sequence decision model to generate a sequential modeling of the prioritized instruction embeddings, wherein the prioritized instruction embeddings include an output of a scalar weighting function calculated by the priority-based instruction manager; and
generating at least one robot command based on the sequential modeling of the prioritized instruction embeddings.

9. The system of claim 8, wherein the sequence decision model comprises a neural network trained for sequential modeling of dynamic human interaction, and is selected from a transformer, a recurrent neural network, or a long short-term memory network.

10. The system of claim 8, wherein the user set is defined by persons present within a defined geographical area, an organized set of persons with authorization to perform a specified task, and combinations thereof.

11. The system of claim 8, wherein the priority-based instruction manager dynamically reprioritizes tasks based on a change to the user set, and wherein the priority-based instruction manager is configured to evaluate each user's identity, authority level, and contextual role using multimodal inputs, site contextual memory, and combinations thereof.

12. The system of claim 11, wherein evaluating the user's identity and authority level includes cross-referencing user data with a database to determine the authority levels and contextual role.

13. The system of claim 8, wherein the generated robot commands are configured to update a robot's task queue in real time.

14. The system of claim 8, wherein the memory further includes executable instructions that, when executed by the processor, cause the system to perform functions of:
providing feedback to a user set member, wherein the feedback includes task prioritization information and command execution status information.

15. A non-transitory computer readable medium on which are stored instructions that when executed cause a programmable device to:
receive a plurality of instructions from a plurality of users, wherein the users are members of a user set;
process the instructions through a priority-based instruction manager, wherein the priority-based instruction manager is in data communication with a database, wherein the database comprises context information about members of the user set;
generate prioritized instruction embeddings via the priority-based instruction manager that contextualize the received instructions for decision making;
input the prioritized instruction embeddings into a sequence decision model to generate a sequential modeling of the prioritized instruction embeddings, wherein the prioritized instruction embeddings include an output of a scalar weighting function calculated by the priority-based instruction manager; and
generate at least one robot command based on the sequential modeling of the prioritized instruction embeddings.

16. The non-transitory computer readable medium of claim 15, wherein the sequence decision model comprises a neural network trained for sequential modeling of dynamic human interaction, and is selected from a transformer, a recurrent neural network, or a long short-term memory network.

17. The non-transitory computer readable medium of claim 15, wherein the user set is defined by persons present within a defined geographical area, an organized set of persons with authorization to perform a specified task, and combinations thereof.

18. The non-transitory computer readable medium of claim 15, wherein the priority-based instruction manager dynamically reprioritizes tasks based on a change to the user set, and wherein the priority-based instruction manager is configured to evaluate each user's identity, authority level, and contextual role using multimodal inputs, site contextual memory, and combinations thereof, and wherein evaluating the user's identity and authority level includes cross-referencing user data with a database to determine the authority levels and contextual role.

19. The non-transitory computer readable medium of claim 15, wherein the generated robot commands are configured to update a robot's task queue in real time.

20. The non-transitory computer readable medium of claim 15, wherein the instructions when executed further cause the programmable device to:
provide feedback to a user set member, wherein the feedback includes task prioritization information and command execution status information.
